(19) United States
(12) Patent Application Publication
(10) Pub. No.: US 2012/0248016 A1
(43) Pub. Date: Oct. 4, 2012

(54) FLUID HANDLING AND CLEANING CIRCULATION SYSTEM

(75) Inventor: Min-Lu Liou, New Taipei City (TW)

(73) Assignee: Green Power Technology Co., Ltd., New Taipei City (TW)

(21) Appl. No.: 13/238,657

(22) Filed: Sep. 21, 2011

(30) Foreign Application Priority Data
Mar. 31, 2011 (TW) 100205748

(51) Int. Cl. B01D 36/00

(52) U.S. Cl. 210/103; 210/137

(57) ABSTRACT

A fluid handling and cleaning circulation system includes a storage device storing circulation liquid, a circulating pipeline to circulate the circulation liquid, a filter device to filter the circulation liquid, and a purification separator to remove impurities from and to divide the circulation liquid into a recyclable flow body and an excitation flow body. The purification separator has a first outlet for outletting the excitation flow body, a second outlet for outletting the recyclable flow body to the filter device, and an inlet for inletting the circulation liquid. A nano excitation device is disposed downstream of the first outlet for exciting and nanolizing the excitation flow body. A flow control device pressurizes and accelerates the circulation liquid so that the circulation liquid flows at predetermined velocity and pressure from the storage device, through the filter device, the purification separator and the nano excitation device, and back to the storage device.

### CROSS-REFERENCE TO RELATED APPLICATION

This application claims priority of Taiwanese Application No. 100205748, filed on Mar. 31, 2011.

### BACKGROUND OF THE INVENTION

1. Field of the Invention

This invention relates to a circulation system, and more particularly to a fluid handling and cleaning circulation system to clean a circulation liquid in the system.

2. Description of the Related Art

Referring to FIG. 1, a circulating equipment 1 of a large scale central air-conditioning system is exemplified, and is shown to include a storage device 11, and a circulating pipeline 12 connected fluidly to the storage device 11 and a cooling tower 100 of the central air-conditioning system. The storage device 11 is a water tank. Liquid circulating in the circulating equipment 1 is water. Water is stored in the storage device 11, and circulates continuously in a loop formed by the storage device 11 and the pipeline 12, and passes through the cooling tower 100 for cooling. As such, a normal operation of the cooling tower 100 can be maintained.

Experiments reveal that the quality of water flowing in the pipeline 12 gradually degrades as the water continuously circulates in the system due to suspended particles in the air, dust, and/or impurities in refilled water that are mixed with the water in the storage device 11. Further, when water in the storage device 11 evaporates, concentration of salts in the water increases. When the concentration of the salts reaches a saturation point, it will start to settle and form scale which can degrade the structure of the storage device 11, increase heat conductivity resistance, and block water circulation in the system. Hence, not only is heat exchanging operation affected, but also the service life of the pipeline 12 will be shortened.

Currently, the maintenance of the circulating equipment 1 includes periodically cleaning of the storage device 11, and analyzing the water circulating in the pipeline 12. The water is subjected to component analysis, conductivity analysis, etc. According to the quality of water, a chemical agent is added to the water so as to lower the hardness of water, to minimize formation of scale, and to eliminate bacteria and algae. Examples of the chemical agent include: a sterilizing agent, an algaecide, a pipeline cleaning agent, a pickling inhibitor, a descaling agent, a scale softener, a corrosion inhibitor, an aluminum fin cleaning agent, a boiler water treatment agent, an antibacterial agent, a bleaching agent, etc.

However, since only the chemical agent is added to improve the quality of water, water is not only easily polluted that leads to occurrence of subsequent environmental problems, but also if the chemical agent is acidic, the pipeline 12 corrodes easily; and if the chemical agent is basic, scale is easily formed in, for example, in the cooling tower 100 and pipelines of the air-conditioning equipment.

Further, since the volume and the condition of water circulating in the circulating equipment 1 cannot be accurately calculated, the addition of the chemical agent is performed based on experience and visual effect. Moreover, the added chemical agent cannot simultaneously react to form a change, so that the problem of putting excessive or less amount of the chemical agent occurs. This results in corrosion of the equipment, formation of scale, and cannot kill bacteria or algae because a chemical resistant is already formed.

### SUMMARY OF THE INVENTION

Therefore, an object of the present invention is to provide a fluid handling and cleaning circulation system that employs physically cleaning a circulation liquid in the system.

According to this invention, a fluid handling and cleaning circulation system comprises a storage device storing a circulation liquid, a circulating pipeline connected fluidly to the storage device to circulate the circulation liquid, a filter device disposed downstream of the storage device and connected fluidly to the circulating pipeline to filter the circulation liquid, a purification separator, a nano excitation device, and a flow control device. The filter device filters particles having a diameter greater than 200 microns. The purification separator is disposed downstream of the filter device to remove impurities from the circulation liquid and to divide the circulation liquid into a recyclable flow body to be sent back to the filter device, and an excitation flow body to be excited. The purification separator has a first outlet for outletting the excitation flow body, a second outlet connected to the filter device for outletting the recyclable flow body to the filter device, and an inlet for inletting the circulation liquid. The nano excitation device is disposed downstream of the first outlet of the purification separator for exciting and nanolizing the excitation flow body. The flow control device pressurizes and accelerates the circulation liquid so that the circulation liquid flows at predetermined velocity and pressure from the storage device, through the filter device, the purification separator and the nano excitation device, and back to the storage device.

The advantage of the present invention resides in that through the provision of the flow control device to increase the velocity of the circulation liquid, and in conjunction with the nano excitation device that excites the circulation liquid, the circulation liquid in the system is cleaned physically. Further, the cleaned circulation liquid can be simultaneously recycled and reuse in the system. Hence, the fluid handling and cleaning circulation system of the present invention can achieve environmental protection and energy- and water-saving purposes.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a conventional circulating equipment;

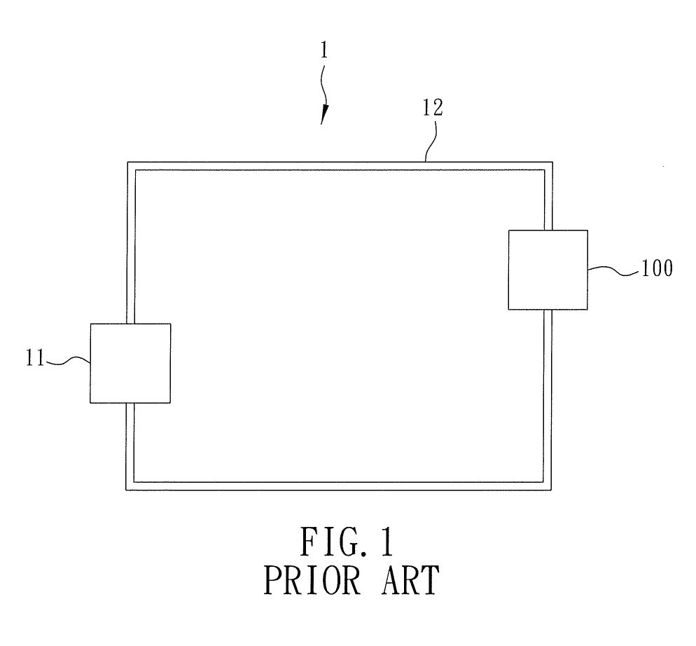

FIG. 2 is a schematic view of a fluid handling and cleaning circulation system according to the preferred embodiment of the present invention;

FIG. 3 is a schematic side view of a filter device of the preferred embodiment;

FIG. 4 is a partial sectional view of a purification separator of the preferred embodiment; and

FIG. 5 is a sectional view of a nano excitation device of the preferred embodiment.

### DETAILED DESCRIPTION OF THE PREFERRED EMBODIMENT

The above-mentioned and other technical contents, features, and effects of this invention will be clearly presented from the following detailed description of a preferred embodiment in coordination with the reference drawings.

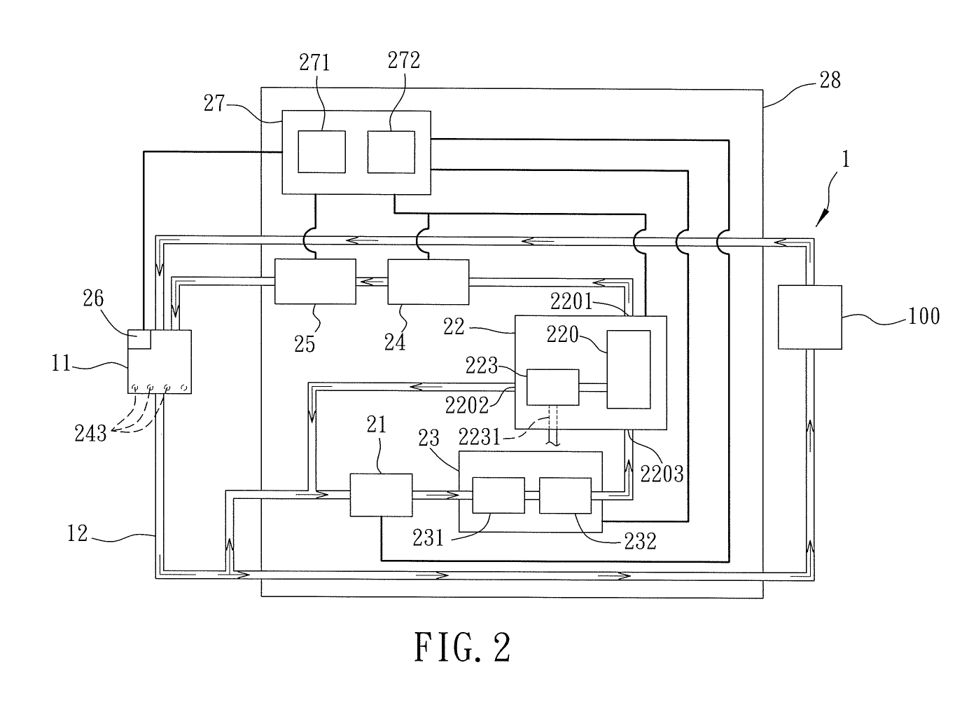

Referring to FIGS. 2 to 5, a fluid handling and cleaning circulation system according to the preferred embodiment of the present invention comprises a circulating equipment 1, a filter device 21, a purification separator 22, a flow control device 23, a nano excitation device 24, an ultra-violet (UV) sterilization device 25, an algaecide device 26, a control sensor unit 27, and a housing 28. The circulating equipment 1 of a large scale central air-conditioning system is exemplified herein, and includes a storage device 11 storing a circulation liquid, and a circulating pipeline 12 connected fluidly to the storage device 11 to circulate the circulation liquid and passing through a cooling tower 100 of the air-conditioning system. The circulation liquid in the system is water. Through a by-pass method, 30% of the circulation liquid is introduced into the circulating equipment 1 to physically clean the circulating equipment 1 and the circulation liquid, after which the circulation liquid is sent back into the circulating equipment 1 for circulation. The circulation liquid circulates conti-nuously in a loop formed by the storage device 11 and the pipeline 12, and passes through the cooling tower 100 for cooling. As such, a normal operation of the cooling tower 100 can be maintained.

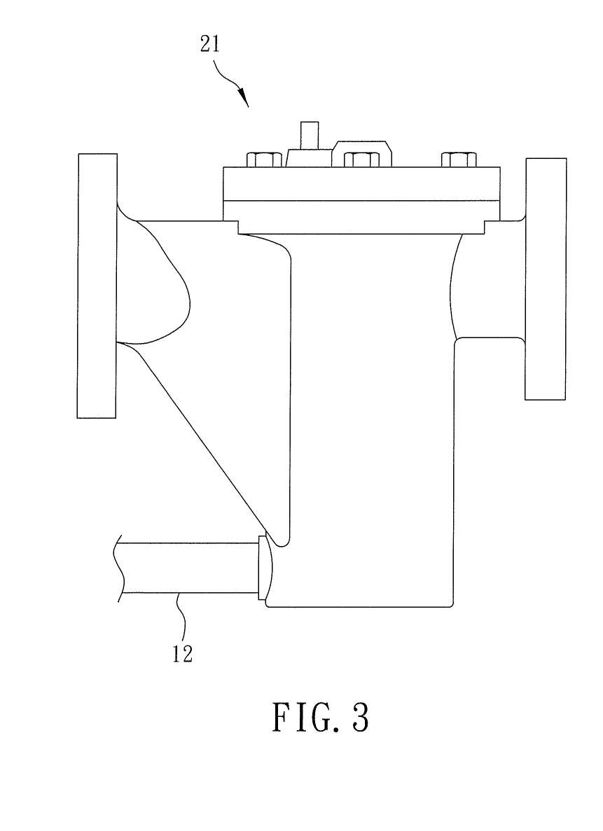

With reference to FIG. 3, the filter device 21 is disposed downstream of the storage device 11, and is connected fluidly to the circulating pipeline 12. The circulation liquid from the storage device 11 flows through the pipeline 12 and the filter device 21. The filter device 21 filters the impurities in the circulation liquid. Impurities with particles having a diameter greater than 200 microns are filtered in the filter device 21. In this embodiment, the filter device 21 is configured as a Y-shaped filter strainer with a differential pressure control switch.

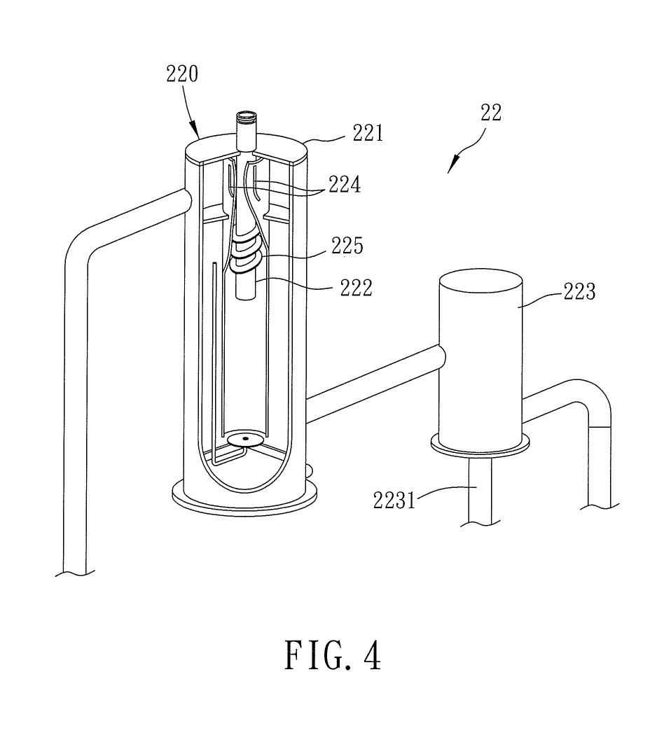

With reference to FIG. 4, in combination with FIG. 2, the purification separator 22 is disposed downstream of the filter device 21 to remove impurities from the circulation liquid and to divide the circulation liquid into a recyclable flow body to be sent back to the filter device 21, and an excitation flow body to be excited. The purification separator 22 includes a centrifuge 220 for separating solid impurities (or slurry) from the excitation flow body, and a solid collector 223 connected fluidly to the tubular casing 221 to collect the solid impurities from the centrifuge 220. The centrifuge 220 has a tubular casing 221 with a plurality of filter holes 224, and an agitator 222 disposed in the tubular casing and having blades 225. The solid impurities are discharged via a discharge tube 2231. The solid impurities may include mud, algae, metal shavings, suspended articles, calcium carbonate, and/or calcium chloride. When the excitation flow body flows into the tubular casing 221, the excitation flow body pushes the agitator 222 to rotate about its own axis to thereby separate the solid impurities from the excitation flow body. The purification separator 22 has a first outlet 2201 for outletting the excitation flow body, a second outlet 2202 connected to the filter device 21 for outletting the recyclable flow body to the filter device 21, and an inlet 2203 for inletting the circulation liquid.

The flow control device 23 includes a motor pump 231 for pressurizing the circulation liquid, and a control valve 232 for adjustably controlling the velocity and pressure of the circulation liquid pressurized by the motor pump 231. Hence, the flow control device 23 pressurizes and accelerates the circulation liquid so that the circulation liquid flows at predetermined velocity and pressure from the storage device 11, through the filter device 21, the purification separator 22, and the nano excitation device 24, and back to the storage device 11. In this embodiment, the circulation liquid is pressurized to have a velocity of about 2.0-2.5 m/sec and a pressure of not below 6 kg/cm².

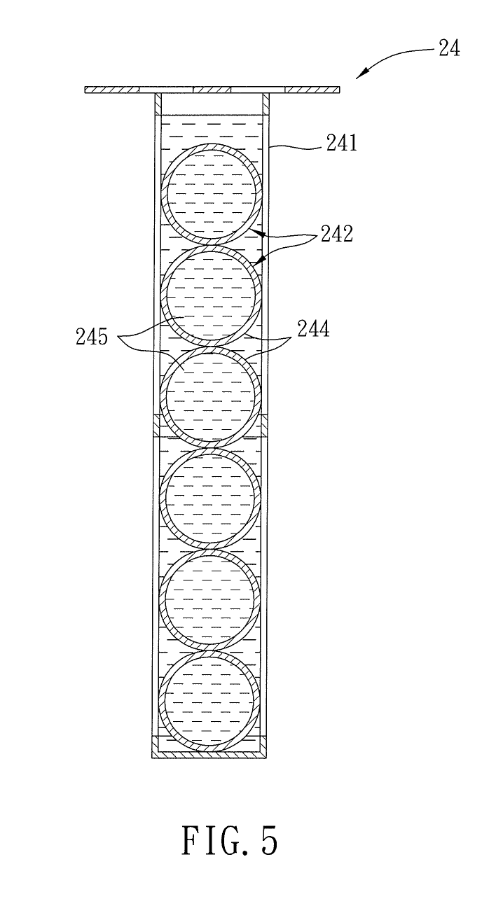

With reference to FIG. 5, in combination with FIG. 2, the nano excitation device 24 is disposed downstream of the first outlet 2201 of the purification separator 23 for exciting and nanolizing the excitation flow body. The nano excitation device 24 includes an oscillating cylinder 241, and a plurality of nano excitation balls 242 disposed in the oscillating cylinder 241. The nano excitation balls 242, in this embodiment, are stainless steel balls, and have steel shells 244 filled with oscillating liquid 245 (which include ferritic material). When the excitation flow body contacts the nano excitation balls 242, the oscillating liquid 245 in the steel shells 244 of the nano excitation balls 242 acts upon the excitation flow body to excite and nanolize the excitation flow body through a predetermined frequency.

A spray nozzle unit is connected to the nano excitation device 24 and the storage device 11, and includes a plurality of spray nozzles 243 for spraying the excitation flow body into the storage device 11 so as to stir the circulation liquid that is stored in the storage device 11 and to clean an internal portion of the storage device 11.

Reference back to FIG. 2, the ultraviolet (UV) sterilization device 25 is disposed downstream of the nano excitation device 24 to sterilize the excitation flow body by radiating UV rays onto the excitation flow body. Preferably, the UV sterilization device 25 is connected to an outlet end of the nano excitation device 24 so that as the excitation flow body passes through the UV sterilization device 25, the excitation flow body is sterilized through ultraviolet irradiation.

In this embodiment, the algaecide device 26 is disposed in the storage device 11. The algaecide device 26 treats the excitation flow body using ultrasonic waves. When the ultrasonic waves penetrates into the water, the microorganisms in the excitation flow body start to quiver through the frequency of the ultrasonic waves so that the cytoplasm and cell membrane thereof are stripped, especially destroying the bladder that controls the elevation of algal cells. Further, when the bladder is cavitated and destroyed, the high-temperature high-pressure large amount of free radicals created by cavitation can destroy the active mould and active matters in the algal cells, thereby stripping the excitation flow body of the algal cells in a method that does not involve chemicals.

The control sensor unit 27 has a sensor 271 and a controller unit 272. The sensor 271 monitors the filter device 21, the purification separator 22, the flow control device 23, the nano excitation device 24, the UV sterilization device 25, and the algaecide device 26. The controller 272 enters a command to control selectively the flow control device 23, the UV sterilization device 25, and the algaecide device 26. In this embodiment, the control sensor unit 27 is a group control microcomputer, and includes a motor pump ON/OFF indicator, a motor pump running time indicator, a self-restoration indicator (after power interruption), a microcomputer battery power indicator, a motor pump failure indicator, a water pipe pressure loss indicator, an electromagnetic valve clogging indicator, an abnormal voltage indicator, an abnormal flow release indicator, an abnormal water pressure differential release indicator, a nano excitation device energy weakening indicator, an abnormal electrical conductivity indicator, an abnormal pH indicator, a 3-month manual control indicator, a 4-month automatic control indicator, an insertable time control indicator, a UV sterilization device indicator, an algaecide device indicator, safety codes, etc.

The housing 28 receives the filter device 21, the purification separator 22, the flow control device 23, the nano excitation device 24, the UV sterilization device 25, and the control sensor unit 27 to protect these devices from being crushed by falling objects, from acid rain, and from corrosion due to moisture. Particularly, the housing 28 is provided with louvered holes to permit heat exchange and convection between inner and outer portions of the housing 28 and to cool the motor pump 231.

From the aforesaid detailed description of each device, the primary concern of the present invention is to circulate the circulation liquid in the circulating equipment 1 through a bypass method. The circulation liquid is pressurized by the flow control device 23 to flow at predetermined velocity and pressure, after which the circulation liquid is first filtered in the filter device 21 to remove impurities of large grain sizes, and is then filtered a second time in the purification separator 22. In the purification separator 22, the circulation fluid is divided into the recyclable flow body which is sent back to the filter device 21, and the excitation flow body to be excited. The excitation flow body passes through the nano excitation device 24 so as to be excited and nanolized, and is further used for cleaning the circulating equipment 1. Simultaneously, in conjunction with the UV sterilization device 25 and the algaecide device 26, the circulation liquid circulating in the circulating equipment 1 can be improved and the whole structure of the circulating equipment 1 can be cleaned. Not only electricity and water can be conserved, but also no chemical agents are added in the system, so that discharge of chemical wastewater or water containing heavy metals can be prevented.

Through an experiment conducted by SGS Taiwan Limited on the fluid handling and cleaning circulation system of the present invention, the quality of water in a circulating equipment of the system is reported to contain 23×10³ CFU/ml of bacteria prior to installation of the fluid handling and cleaning circulation system of this invention, and is less than 18 CFU/ml after the installation of the fluid handling and cleaning circulation system of this invention. It is evident that the fluid handling and cleaning circulation system of this invention can truly inhibit bacterial growth.

Through another experiment conducted by Yuan Ze University Environmetal Technology Research Center on a corrosion test on a circulating equipment installed with the fluid handling and cleaning circulation system of this invention, the results are: Carbon steel has a corrosion rate of less than 2 mpy; and Copper has a corrosion rate of less than 0.5 mpy. The standard corrosion rate obtained is “good.” It is evident that the fluid handling and cleaning circulation system of this invention can improve corrosion condition of the circulating equipment of a system.

Moreover, Yuan Ze University Environmetal Technology Research Center also conducted an experiment on the particle diameter of water in a circulating equipment installed with the fluid handling and cleaning circulation system of this invention. The molecular particle diameter of tap water averages 30-50 nm, whereas the molecular particle diameter of water after using the fluid handling and cleaning circulation system of this invention averages 5-20 nm. It is evident that the fluid handling and cleaning circulation system of the present invention has the effect of nanolizing the water to thereby clean the circulating equipment and the water circulating in the circulating equipment.

The water averaging 5-20 nm is also tested for laser problem in the Institute for Radiation Protection Association. Through testing of an outer surface and a distance spaced apart from the outer surface by 10 cm, a radiation dose of less than 0.1 pSv/h is measured. Hence, there is no need to worry about laser safety.

Electrical conductivity of water in the circulating equipment in a system is also tested by SGS Taiwan Limited. After using the fluid handling and cleaning circulation system of this invention, the electrical conductivity reduces from 2700 μmho/cm to 2080 μmho/cm. It is evident that the fluid handling and cleaning circulation system of this invention has a cleaning effect after using it for about 30 days.

Additionally, the fluid handling and cleaning circulation system of this invention is also installed and experimented in the following: a circulating equipment which has been in used for many years by an electronic company, a large amount of impurities was removed from the condenser; a newly operated circulating equipment in a hospital, no impurities was found in the condenser; a circulating equipment in a department store/hotel, the water tank (i.e., the storage device of the circulating equipment) has no breeding of algae, and slurry deposit has minimized.

In summary, the fluid handling and cleaning circulation system of this invention can quickly nanolize, for example, circulating water in the circulating equipment of a central air-conditioning system so as to remove and prevent formation of impurities in the cooling tower and the circulating equipment, so that the equipment is restored to a condition similar to that of a newly installed one in the system. Further, during treatment, water is circulated for cleaning. Hence, not only use of electricity can be saved, but also use of water. Simultaneously, unlike the conventional treating method, the present invention does not use chemical agents, so that discharge of chemicals or heavy metals can be prevented. Thus, the effect of environmental protection, energy saving, and water conservation can be achieved. Therefore, the object of the present invention can be realized.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A fluid handling and cleaning circulation system comprising:
a storage device storing a circulation liquid;
a circulating pipeline connected fluidly to said storage device to circulate the circulation liquid;
a filter device disposed downstream of said storage device and connected fluidly to said circulating pipeline to filter the circulation liquid, said filter device filtering particles having a diameter greater than 200 microns;
a purification separator disposed downstream of said filter device to remove impurities from the circulation liquid and to divide the circulation liquid into a recyclable flow body to be sent back to the filter device, and an excitation flow body to be excited, said purification separator having a first outlet for outletting the excitation flow body, a second outlet connected to said filter device for outletting the recyclable flow body to said filter device, and an inlet for inletting the circulation liquid;
a nano excitation device disposed downstream of said first outlet of said purification separator for exciting and nanolizing the excitation flow body; and
a flow control device to pressurize and accelerate the circulation liquid so that the circulation liquid flows at predetermined velocity and pressure from said storage device, through said filter device, said purification separator and said nano excitation device, and back to said storage device.

2. The system as claimed in claim 1, wherein said nano excitation device includes an oscillating cylinder, and a plurality of nano excitation balls disposed in said oscillating cylinder, said nano excitation balls having steel shells filled with oscillating liquid, wherein, when the excitation flow body contacts said nano excitation balls, the oscillating liquid in said steel shells acts upon the excitation flow body to excite and nanolize the excitation flowbody through a predetermined frequency.

3. The system as claimed in claim 2, further comprising a spray nozzle unit connected to said nano excitation device and said storage device for spraying the excitation flow body into said storage device.

4. The system as claimed in claim 1, wherein said flow control device has a motor pump.

5. The system as claimed in claim 4, wherein said flow control device further has a control valve for controlling the velocity and pressure of the circulation liquid.

6. The system as claimed in claim 1, wherein said purification separator includes a centrifuge for separating solid impurities from the excitation flow body, said centrifuge having a tubular casing with a plurality of filter holes, and an agitator disposed in said tubular casing and having blades.

7. The system as claimed in claim 6, wherein said purification separator further includes a solid collector connected fluidly to said tubular casing to collect the solid impurities from said centrifuge.

8. The system as claimed in claim 1, further comprising an ultraviolet (UV) sterilization device disposed downstream of said nano excitation device to sterilize the excitation flow body.

9. The system as claimed in claim 8, further comprising an algaecide device to treat the excitation flow body using ultrasonic waves.

10. The system as claimed in claim 9, further comprising a control sensor unit which has a sensor to monitor said filter device, said purification separator, said flow control device, said nano excitation device, said UV sterilization device, and said algaecide device, said control sensor unit further having a controller to control selectively said flow control device, said UV sterilization device, and said algaecide device.

11. The system as claimed in claim 10, further comprising a housing that receives said filter device, said purification separator, said flow control device, said nano excitation device, said UV sterilization device, and said control sensor unit.
